(19) United States
(12) Patent Application Publication
(10) Pub. No.: US 2002/0160213 A1
(43) Pub. Date: Oct. 31, 2002

(54) Elastomer and steel cord composite and process for producing the same

(75) Inventors: Susumu Imamiya, Hiratsuka-shi (JP); Satoshi Yoshida, Ono City (JP)

Correspondence Address: BROWDY AND NEIMARK, P.L.L.C., 624 Ninth Street, N.W., Washington, DC, 20001, US

(73) Assignee: The Yokohama Rubber Co., Ltd., Tokyo (JP)

(21) Appl. No.: 10/109,054

(22) Filed: Mar. 29, 2002

(30) Foreign Application Priority Data
Mar. 30, 2001 (JP) 102723/2001
Mar. 30, 2001 (JP) 102724/2001
Mar. 30, 2001 (JP) 102725/2001

(51) Int. Cl. B32B 15/06

(52) U.S. Cl. 428/465; 57/902

(57) ABSTRACT

In order that spaces, including a space in the central portion, inside a steel cord used as a reinforcement by being embedded in a tire or the like are filled with an uncured rubber, the uncured rubber is coated on plural steel filaments 115 which are then stranded in case of a single layer steel cord, the uncured rubber is coated on all of plural core filaments 329 which are then stranded along with outer layer filaments 330 in the same direction at the same pitch in case of a 2-layer steel cord of 1 stranding process, and the uncured rubber is coated on all or 2 to 4 core filaments 218 or on at least one of 3 or 4 steel filaments 408, 408′ to form a core strand and outer layer filaments 410, 410′ are stranded therearound in case of 2-layer steel cord of 2 stranding process. Consequently, it is possible to exhibit satisfactory corrosion resistance and satisfactory fatigue resistance as a steel cord, shorten a curing time in tire component assembling or the like to attain energy saving and prolong the life of a steel cord itself and the life of a tire or the like using the same as a reinforcement. Further, production can be performed at low cost.

### BACKGROUND OF THE INVENTION

1. Field of Invention

The present invention relates to a steel cord which is used as a reinforcement by being embedded in a tire or the like, and a process for producing the same. More specifically, it relates to an elastomer and steel cord composite which, when used as, for example, a tire reinforcement, can exhibit a satisfactory corrosion resistance and a satisfactory fatigue resistance and which can shorten a curing time in tire component assembling and attain energy saving, and a process for producing the same.

2. Description of the Prior Art

A single layer close-type steel cord obtained by stranding, for example, 3 to 6 filaments (steel filaments) has been so far used as a steel cord for tire reinforcement. FIG. 13 shows a sectional view of a so-called 1×3 steel cord 12 obtained by tightly stranding 3 steel filaments 11 as an example of such close-type steel cord.

In the single layer steel cord obtained by stranding 3 to 6 steel filaments, a close space 13 is formed in the central portion as shown in FIG. 13. This space 13 extends in the longitudinal direction of the cord in a straw state.

The example shown in FIG. 13 is a 1×3 cord. This is the same with 1×4, 1×5 and 1×6 cords, and the space 13 is formed in the central portion.

However, when the space 13 is formed in the central portion of the cord in the close type, a rubber 14 does not permeate the space 13 in the central portion of the cord as shown in FIG. 14 in forming a composite of the steel cord and the rubber in a tire component assembling step, and the space remains as a hollow portion. And, moisture or the like enters the inside of the cord by external damage of a tire surface, reaches the space 13 in the central portion of the cord as the hollow portion, and permeates the inside of the cord by capillarity in a longitudinal direction. As a result, corrosion proceeds from inside the cord, which might decrease fatigue resistance of the steel cord to shorten the life of the tire.

Therefore, with respect to a single layer steel cord, for example, open-type cords in which spaces are formed between filaments and rubber permeates the inside of the cord through the spaces, such as a loose open cord obtained by loosely stranding helically formed filaments as shown in JP-A 62-170594 or the like and a flat open cord obtained by loosely stranding filaments formed in a oval helical shape as shown in JP-A 2-133687 or the like have been proposed and used.

In these open-type steel cords, the spaces inside the cords are filled by permeating the rubber inside the cord in tire component assembling. Accordingly, even when moisture or the like enters owing to external damage in the tire surface, it does not permeate the inside of the cord immediately, solving a problem of corrosion from inside the cord to increase fatigue resistance.

Nevertheless, the open-type steel cord has, in comparison with the close-type steel cord, a large volume of the space inside the cord, and an amount of air remaining within the cord is large. Accordingly, an amount of air incorporated in a rubber at the time of tire component assembling is increased, and air pushed out from inside the cord in tire component assembling remains as voids (air trapping) in the tire rubber which results in damaging the strength of the tire body. Therefore, for diffusing such air and eliminating voids, it is required to prolong curing time in tire component assembling, which decreases productivity and increases consumption energy.

Further, a close-type steel cord in which a space in the central portion of a cord is filled with a non-metallic core material to prevent formation of a hollow portion in the central portion of the cord and moisture or the like entered owing to external damage in the tire surface does not permeate the inside of the cord to prevent corrosion and improve fatigue resistance has been also proposed. For example, in a steel cord demonstrated in JP-A 61-138789, a central portion of a cord is filled with an organic core material. Further, in a steel cord demonstrated in JP-B 59-24239, a cured rubber is used as a core material.

When the space in the central portion of the cord is filled with such non-metallic core material, a problem of corrosion caused by permeating moisture or the like entered owing to external damage in the tire surface can be solved to increase fatigue resistance. However, with respect to the use of the core material such as the organic material or the like, both adhesion with rubber of a tire body and adhesion with steel filaments have to be taken into account, and designing is much restricted. Thus, it is indeed disadvantageous in view of the technique and the cost.

Further, as the steel cord for tire reinforcement, a 2-layer steel cord obtained by stranding plural filaments (steel filaments) in inner and outer 2 layers has been so far used. As an example of the 2-layer steel cord, FIG. 15 shows a sectional view of a so-called 3+9 steel cord 24 in which 3 steel filaments 21 are stranded to form a core strand 22 and 9 steel filaments 23 as outer layer filaments are arranged around the resulting core strand 22 and stranded in a different direction or at a different pitch from that of the core strand 22.

In the steel cord obtained by thus stranding the plural steel filaments in 2 layers, as shown in FIG. 15, a space 25 extending in a straw state in a longitudinal direction of the strand is formed in the central portion of the core strand 22, and spaces 26 are formed within outer layer steel filaments (between the steel filaments 23 and the core strand 22).

The example shown in FIG. 15 is a 3+9 steel cord, and this is also the case with an (m+n) (m=2 to 4) 2-layer steel cord. Spaces are formed within outer layer steel filaments (between the outer layer steel filaments and a core strand), and air is trapped in these spaces. These spaces are reduced by permeating the rubber coated on the cord surface inside the cord, for example, when curing and pressing the rubber in a tire component assembling step. However, the rubber hardly permeates the space in the central portion of the strand, and a hollow portion longitudinally extending in a straw state remains in the central portion of the steel cord while being embedded in rubber material of a tire. As a result, a fretting abrasion occurs within the steel cord during use of the tire. Further, moisture or the like incorporated into the tire owing to external damage or crack of the tire sometimes reaches the space in the central portion of the strand. The moisture is permeated in a longitudinal direction of the cord by capillarity, and corrosion proceeds within the cord. Consequently, properties (strength and fatigue resistance) of the steel cord in the tire are notably decreased to shorten the product life of the tire.

Moreover, the influence of the space remaining within the steel cord is not only that, but air remaining in the space is exhausted in tire component assembling to cause air trapping, and this air remains in the rubber to impair the strength of the tire body too. Accordingly, for diffusing such air and eliminating air trapping, a curing time has to be prolonged in tire component assembling, which decreases productivity and increases consumption energy.

As an improvement of such (m+n) steel cord, there is also a proposal of a steel cord in which outer layer filaments are slightly decreased in number as compared with filaments in tight stranding to provide spaces between the outer layer filaments for facilitating permeation of rubber in tire component assembling. For example, in a steel cord shown in JP-A 7-109685, the number of sheath filaments (outer layer filaments) is set at 7 or 8 relative to 3 core filaments for enabling permeation of rubber in spaces between the sheath filaments and the core filaments. In such a structure, however, it is also difficult to completely fill the spaces within the steel cord with the rubber. In comparison with tight stranding, a life of a tire can slightly be prolonged, however not satisfactory.

Further, in the 2-layer steel cord obtained by stranding the outer layer filaments around the core strand, stranding is conducted in 2 steps, which involves high production cost. Therefore, a 2-layer steel cord produced at low production cost is required. There is also a proposal of a 2-layer steel cord of 1 stranding process in which plural outer layer filaments (n-filaments) are arranged around plural core filaments (m-filaments) and all of these steel filaments are stranded in a 2-layer structure in the same direction at the same pitch. As an example of such a 2-layer steel cord of 1 stranding process, FIG. 16 shows a sectional view of a so-called 3/9 structure of steel cord 27 in which 9 steel filaments 23′ as outer layer filaments are arranged around 3 steel filaments 21′ as core filaments and all of these filaments are stranded in a 2-layer structure in the same direction at the same pitch.

Nevertheless, in the steel cord obtained by stranding the plural core filaments and the plural outer layer filaments at once in the same direction at the same pitch, the stranding direction and the stranding pitch of the core filaments are the same as those of the outer layer filaments. Consequently, drop occurs in the outer layer filaments in the form adhered to the filaments of the core strand obtained by stranding the plural core filaments. Thus, as shown in FIG. 16, not only space 28 in the central portion of the strand but also spaces 29 inside the outer layer filaments 23′ become closed.

Accordingly, the volumes of the spaces inside the outer layer filaments are decreased in comparison with a 2-layer steel cord of 2 stranding process to decrease an amount of air exhausted in the rubber at the time of tire component assembling. However, the rubber hardly permeates the inside of the cord in tire component assembling. As a result, a fretting abrasion also occurs within the steel cord during use of the tire, and moisture or the like enters the inside of the steel cord owing to external damage in the tire surface, which might decrease fatigue resistance of the tire cord to shorten the life of the tire.

Moreover, although the volumes are decreased in comparison with the 2-layer steel cord of 2 stranding process, spaces remain. Air remaining in the spaces in the central portion is exhausted in tire component assembling to cause air trapping, and this air remains in the rubber to impair the strength of the tire body. For diffusing such an air and eliminating air trapping, a curing time has to be prolonged in tire component assembling, which decreases a productivity and increases a consumption energy.

There is further proposal that in the 2-layer steel cord of 1 stranding process a diameter of a core filament is larger than that of an outer layer filament to secure a space between filaments for permeating the rubber into the cord as described in, for example, JP-A 62-125085. However, in this structure, it is also hard to completely fill the spaces inside the cord with the rubber. The life of the tire can slightly be prolonged, however not satisfactory.

Moreover, there are proposals that a water-absorbent polymer is present in spaces inside a steel cord as described in JP-A 6-49786, that an organic core material is filled in a steel cord as described in JP-A 61-138789 and that a cured rubber is used as a core material of a steel cord as described in JP-B 59-24238. However, in the use of the water-absorbent polymer, the organic material or the like, it is necessary to take both an adhesion with a rubber of a tire body and an adhesion with steel filaments into account. Thus, designing is much restricted. It is indeed disadvantageous in view of the technique and the cost.

In the ordinary single layer steel cord obtained by stranding 3 to 6 steel filaments, especially in case of the close type, there is a problem that the space in the central portion of the cord remains as a hollow portion in tire component assembling or the like and moisture or the like enters the hollow portion to cause corrosion from inside the cord. In case of the open type, such a problem of corrosion from inside the cord by incorporation of moisture or the like is solved, but the amount of air incorporated in the rubber in tire component assembling or the like is increased. For diffusing this air and eliminating voids, the curing time has to be prolonged, posing a problem of consuming huge energy. Moreover, when the space in the central portion of the close-type cord is filled with a nonmetallic core material, adhesion between the core material and the rubber of the tire body and adhesion with steel filaments have to be taken into account, which is disadvantageous in view of the technique and the cost.

In addition, in the ordinary 2-layer steel cord, the spaces are formed in the central portion of the core strand and inside the outer layer filaments (between the outer layer filaments and the core strand), and a sufficient amount of rubber does not permeate the inside of the cord in tire component assembling. Especially, the rubber does not permeate the space in the central portion of the core strand in tire component assembling or the like, and the space remains as a hollow portion in a straw state. The spaces also remain inside the outer layer filaments. Consequently, a fretting abrasion occurs inside the steel cord during use of the tire. Further, moisture or the like entered into the tire owing to outer damage or crack of the tire during use of the tire reaches the space in the central portion of the core strand, and permeates the inside of the cord in a longitudinal direction. Accordingly, corrosion proceeds from inside, which might notably decrease strength or fatigue resistance of the steel cord in the tire to shorten the life of the tire. Further, when air in the spaces inside the steel cord remains in the rubber owing to air trapping, the strength of the tire body is impaired. For eliminating the air trapping, curing time has to be prolonged in tire component assembling, which poses problems of decreasing productivity and increasing consumption energy.

Even when the number of outer layer filaments is decreased, for solving these problems, to provide spaces between filaments for facilitating permeation of the rubber, it is difficult to completely fill the space in the central portion of the core strand with the rubber. Further, in the 2-layer steel cord of 1 stranding process for decreasing the production cost, drop occurs in the outer layer filaments, and the spaces between the filaments are in a close state, which causes fretting abrasion and decreases fatigue resistance by incorporation of moisture or the like. For eliminating air trapping, curing time has to be prolonged, which poses problems of decreasing productivity and increasing consumption energy. Still further, in the use of the water-absorbent polymer, the organic material and the like, both the adhesion with the rubber of the tire body and the adhesion with the steel filaments have to be taken into account, which is disadvantageous in view of the technique and the cost.

### OBJECTS AND SUMMARY OF THE INVENTION

The invention is for solving these problems. Objects of the invention are that the life of a single layer or 2-layer steel cord itself which is used as a reinforcement by being embedded in a tire or the like is prolonged by satisfactorily exhibiting corrosion resistance and fatigue resistance, the life of a tire or the like using the same as a reinforcement is prolonged, and curing time in tire component assembling or the like is shortened to attain energy saving and allow production at low cost.

The invention provides, as a steel cord to solve the foregoing problems, an elastomer and steel cord composite which is a single layer steel cord obtained by stranding 3 to 6 steel filaments, characterized in that an uncured rubber is coated on at least one of the steel filaments and this uncured rubber fills a space in the central portion of the cord.

And, it provides, as a process for producing the same, a process for producing an elastomer and steel cord composite, characterized by previously coating an uncured rubber on at least one of steel filaments, and simultaneously stranding 3 to 6 steel filaments including the uncured rubber-coated filament to form a single layer elastomer and steel cord composite.

By this process, 3 to 6 steel filaments including the uncured rubber-coated filament are simultaneously stranded to obtain the single layer elastomer and steel cord composite in which the space in the central portion of the cord is filled with the uncured rubber.

And, the elastomer and steel cord composite is embedded in the rubber of a tire body in a tire component assembling step as, for example, a tire reinforcement, whereby the uncured rubber is cured to fill the space in the central portion of the cord, which can prevent, for example, a hollow portion from remaining in the central portion of the cord inside the tire and stop corrosion from inside the cord owing to moisture or the like, improve fatigue resistance of the steel cord and prolong the life of a rubber product such as a tire or the like.

Further, since the space in the central portion of the cord is filled and the amount of air incorporated in the rubber by the cord in tire component assembling is decreased, the curing time in tire component assembling or the like can be minimized to reduce energy loss.

The uncured rubber is good in adhesion with the rubber of a tire body and adhesion with steel filaments, posing no problem in view of the technique and the cost.

For completely filling the space in the central portion of the cord, it is advisable to coat the uncured rubber on all of the steel filaments to be stranded.

It is further advisable that the uncured rubber to be previously coated on the steel filament(s) has the same quality as the tire rubber in view of the adhesion, the cost and the like.

In this manner, the single layer elastomer and steel cord composite is obtained in which the uncured rubber fills the space in the central portion of the cord. When the elastomer and steel cord composite is used for tire reinforcement or the like, the hollow portion in the central portion of the cord is completely filled, whereby corrosion from inside the cord by incorporation of moisture or the like can be prevented to improve fatigue resistance of the steel cord and the amount of air incorporated in the rubber by the cord in tire component assembling can be decreased to shorten the curing time and suppress wasteful energy consumption.

Moreover, the invention provides, as a steel cord for solving the foregoing problems, an elastomer and steel cord composite which is a 2-layer steel cord obtained by stranding plural steel filaments as core filaments to form a core strand and stranding plural steel filaments as outer layer filaments around this core strand, characterized in that an uncured rubber is coated on all of the plural steel filaments as core filaments and this uncured rubber fills the spaces inside the cord.

And, the invention provides, as one process for producing the same, a process for producing an elastomer and steel cord composite, characterized by coating an uncured rubber on all of 2 to 4 steel filaments as core filaments, then simultaneously stranding all of the 2 to 4 steel filaments to form a core strand, and thereafter stranding plural steel filaments as outer layer filaments around the core strand.

According to this process, the 2 to 4 steel filaments coated with the uncured rubber are stranded to form the core strand, and the plural steel filaments are then stranded around the core strand to obtain the 2-layer elastomer and steel cord composite.

In this case, the uncured rubber is previously coated on all of the 2 to 4 steel filaments as the core filaments, and these steel filaments are stranded to obtain the core strand in which, when forming an inner space, the uncured rubber fills the very space and the surroundings are coated with the uncured rubber. And, the plural steel filaments as the outer layer filaments are stranded around the core strand so that the spaces inside the outer layer steel filaments (between the outer layer steel filaments and the core strand) are filled with the uncured rubber.

Thus, the elastomer and steel cord composite is obtained in which all of the inner spaces are filled with the uncured rubber without bleeding the uncured rubber on the surface is obtained. This steel cord is embedded in the rubber of the tire body in tire component assembling as, for example, a tire reinforcement to cure the uncured rubber and completely fill the spaces inside the cord with the rubber. Therefore, no fretting abrasion occurs, and corrosion from inside the cord owing to moisture or the like can be prevented to improve fatigue resistance of the steel cord and prolong the life of a rubber product such as a tire or the like. Further, the spaces inside the cord are filled to decrease the amount of air incorporated into the rubber in tire component assembling, which can allow stable production of a tire and shorten the curing time to reduce energy loss. Still further, the uncured rubber is good in adhesion with the rubber of a tire body and adhesion with steel filaments, and is not problematic in view of the technique and the cost.

In this process, it is advisable that the uncured rubber to be previously coated on the steel filaments has the same quality as a tire rubber in view of the adhesion, the cost and the like.

Thus, the 2-layer elastomer and steel cord composite of 2 stranding process is obtained in which the uncured rubber is filled in the space in the central portion and also the spaces inside the outer layer steel filaments (between the outer layer steel filaments and the core strand). When this elastomer and steel cord composite is used in tire reinforcement or the like, the spaces inside the cord are completely filled with the rubber. As a result, no fretting abrasion occurs, and corrosion from inside the cord owing to moisture or the like can be prevented to improve fatigue resistance of the steel cord. An amount of air incorporated into the rubber in tire component assembling is reduced, which can allow stable production of a tire and shorten the curing time to reduce energy loss.

Moreover, the invention provides, as another process for producing the 2-layer steel cord, the process for producing an elastomer and steel cord composite, characterized by coating an uncured rubber on all of plural steel filaments as core filaments with an uncured rubber, arranging plural steel filaments as outer layer filaments around the plural steel filaments coated with the uncured rubber, and stranding all of the steel filaments in the same direction at the same pitch in a 2-layer structure.

According to this process, the plural steel filaments as the outer layer filaments are arranged around the plural steel filaments coated with the uncured rubber, and all of the steel filaments are stranded in the same direction at the same pitch to obtain the 2-layer elastomer and steel cord composite.

In the thus-obtained elastomer and steel cord composite, the uncured rubber is previously coated on all of the plural steel filaments as core filaments, and these filaments are stranded at once along with the plural steel filaments as outer layer filaments, whereby the spaces in the central portion and between the filaments therearound are in close state, and the uncured rubber is filled in the closed spaces. The steel cord is embedded in the rubber of the tire body in tire component assembling as, for example, a tire reinforcement to cure the uncured rubber and completely fill the spaces inside the cord with the rubber. Accordingly, no fretting abrasion occurs, and corrosion from inside the cord owing to moisture or the like can be prevented to improve fatigue resistance of the steel cord and prolong the life of a rubber product such as a tire or the like. Further, since the spaces inside the cord are completely filled with the rubber even in the 2-layer steel cord of 1 stranding process, the amount of air incorporated into the rubber in tire component assembling is decreased, which can allow stable production of a tire and shorten the curing time to reduce energy loss. The uncured rubber is good in adhesion with the rubber of a tire body and adhesion with steel filaments, which is not problematic in view of the technique and the cost.

In this case as well, it is advisable that the uncured rubber to be previously coated on the steel filaments has the same quality as a tire rubber in view of the adhesion, the cost and the like.

Thus, the 2-layer elastomer and steel cord composite of 1 stranding process is obtained in which the uncured rubber is filled in the closed spaces in the central portion and between the filaments therearound. When the elastomer and steel cord composite is used for tire reinforcement or the like, the spaces inside the cord are completely filled with the rubber even in the 2-layer steel cord of 1 stranding process, no fretting abrasion occurs, and corrosion from inside the cord owing to moisture or the like can be prevented to improve fatigue resistance of the steel cord. The amount of air incorporated in the rubber in tire component assembling is decreased, which can allow stable production of a tire and shorten the curing time to reduce energy loss.

Moreover, the invention provides, as a steel cord for solving the foregoing problems, an elastomer and steel cord composite which is a 2-layer steel cord comprising a core layer obtained by stranding 3 or 4 steel filaments and an outer layer formed of plural steel filaments stranded around the core layer, characterized in that an uncured rubber is coated on at least one of the 3 or 4 steel filaments constituting the core layer, and this uncured rubber fills a space in the central portion of the core layer.

And, the invention provides, as a process for producing the same, a process for producing an elastomer and steel cord composite, characterized by coating an uncured rubber on at least one of 3 or 4 steel filaments as core filaments, simultaneously stranding the 3 or 4 steel filaments including the steel filament(s) coated with the uncured rubber to form a core strand, and then stranding plural steel filaments as outer layer filaments around the core strand.

According to this process, there is obtained the 2-layer elastomer and steel cord composite with the uncured rubber filled in the space in the central portion of the core layer, the 2-layer elastomer and steel cord composite comprising the core layer and the outer layer and obtained by stranding the 3 or 4 steel filaments including the steel filament(s) coated with the uncured rubber to form the core strand and then stranding the plural steel filaments around the core strand.

In the thus-obtained elastomer and steel cord composite, the uncured rubber is coated on the part of the 3 to 4 steel filaments constituting the core layer to fill the space in the central portion of the core layer with this uncured rubber. Accordingly, the cord is embedded in the rubber of a tire body in tire component assembling as, for example, a tire reinforcement, whereby the uncured rubber is cured and completely fills the space in the central portion of the core layer. Further, the rubber can be permeated inside the outer layer filaments and between the filaments where the spaces remain. Therefore, corrosion from the central portion of the cord owing to moisture or the like can be prevented to improve fatigue resistance of the steel cord and prolong the life of a rubber product such as a tire or the like. Moreover, the amount of air incorporated in the rubber in tire component assembling is decreased to eliminate air trapping, making it easy to increase the strength of a tire body. The uncured rubber is good in an adhesion with the rubber of a tire body and adhesion with steel filaments, which is not problematic in view of the technique and the cost.

In the elastomer and steel cord composite, it is advisable to set the diameter and the number of filaments of the core layer and the outer layer such that the average clearance between the steel filaments constituting the outer layer is 2/100 mm or more.

In the elastomer and steel cord composite, the uncured rubber is coated on only at least one of the 3 or 4 steel filaments constituting the core layer, and the space in the central portion of the core layer is filled with the uncured rubber, while the spaces inside the outer filaments and between the filaments remain. Accordingly, it is required to permeate the rubber into these spaces when combining the rubber of a rubber product (a tire or the like) with the cord by curing and pressing. When the average clearance between the steel filaments constituting the outer layer is 2/100 mm or more, the rubber is easily permeated into the remaining spaces in combining the rubber of a rubber product with the cord to surely achieve the foregoing problem.

In this case as well, it is advisable that the uncured rubber to be previously coated on the steel filament(s) has the same quality as the tire rubber in view of the adhesion, the cost and the like.

In this manner, the elastomer and steel cord composite is obtained in which the uncured rubber is coated on at least one of the 3 or 4 steel filaments constituting the core layer and fills the space in the central portion of the core layer. The cord is embedded in the rubber of a tire body in tire component assembling as, for example, a tire reinforcement, whereby the uncured rubber is cured and the space in the central portion of the core layer is completely filled with the rubber. Consequently, corrosion from the central portion of the cord owing to moisture or the like can be prevented to improve fatigue resistance of the steel cord and prolong the life of a tire. Further, the amount of air incorporated in the rubber in tire component assembling is reduced to eliminate air trapping, making it easy to increase the strength of the rubber of a tire body. And, the average clearance between the outer layer filaments is set at 2/100 mm or more, whereby the rubber is permeated inside the outer layer filaments and between the filaments to completely fill the spaces inside the cord with the rubber, making it possible to more improve corrosion resistance and fatigue resistance.

The above and other objects, features and advantages of the invention will become apparent from the following detailed description which is to be read in conjunction with the accompanying drawings.

### BRIEF DESCRIPTION OF THE DRAWINGS

FIG. 1 is a schematic view of a step of producing an elastomer and steel cord composite in 1st Example of the invention;

FIG. 2 is a sectional view of the elastomer and steel cord composite in 1st Example of the invention;

FIG. 3 is a schematic view of a step of forming a core strand in 2nd Example of the invention;

FIG. 4 is a schematic view of a step of stranding outer layer filaments around the core strand in 2nd Example of the invention;

FIG. 5 is a sectional view of the core strand in 2nd Example of the invention;

FIG. 6 is a sectional view of an elastomer and steel cord composite in 2nd Example of the invention;

FIG. 7 is a schematic view of a step of producing an elastomer and steel cord composite in 3rd Example of the invention;

FIG. 8 is a sectional view of an elastomer and steel cord composite in 3rd Example of the invention;

FIG. 9 is a schematic view of a step of forming a core strand in 4th Example of the invention;

FIG. 10 is a schematic view of a step of stranding outer layer filaments around the core strand in 4th Example of the invention;

FIG. 11 is a sectional view of an elastomer and steel cord composite in 4th Example of the invention;

FIG. 12 is a sectional view of another elastomer and steel cord composite according to 4th Example of the invention;

FIG. 13 is a unit sectional view of an example of an ordinary 1×3 steel cord;

FIG. 14 is a sectional view of an ordinary 1×3 steel cord shown in a composite state with the rubber in a tire component assembling step;

FIG. 15 is a sectional view of an ordinary 2-layer steel cord of 2 stranding process; and

FIG. 16 is a sectional view of an ordinary 2-layer steel cord of 1 stranding process.

### DESCRIPTION OF THE PREFERRED EMBODIMENTS

### 1st EXAMPLE

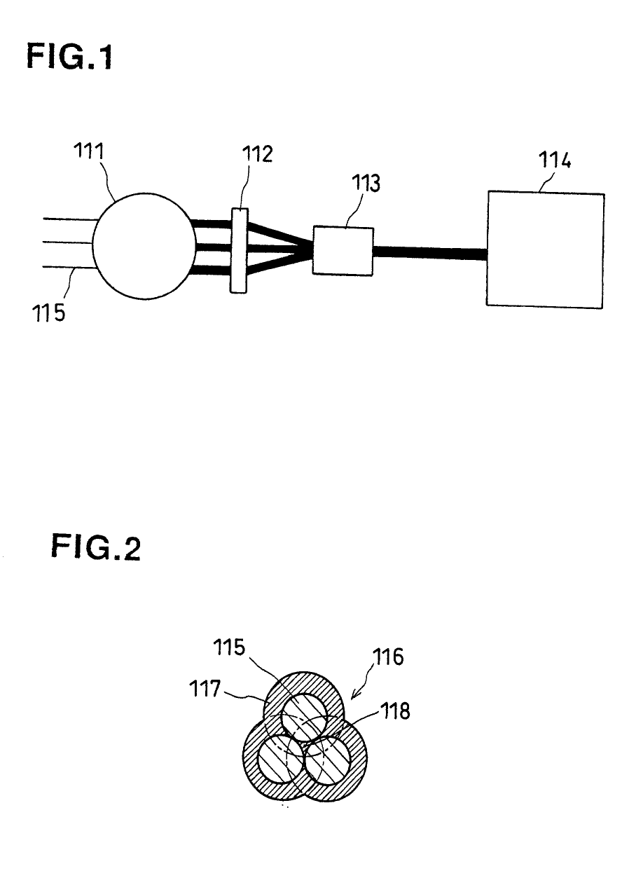

FIG. 1 shows a step of producing an elastomer and steel cord composite in 1st Example of the invention. In FIG. 1, 111 is an uncured rubber coating unit, 112 a wire separator, 113 an inlet die, and 114 a buncher (double twist stranding machine). All the units are those known per se.

This Example is a case of producing a 1×3 elastomer and steel cord composite. Three steel filaments 115 are fed in parallel, and supplied toward an inlet of the buncher (double twist stranding machine) 114. During the supply, each of the three steel filaments 115 is coated with an uncured rubber through the uncured rubber coating unit 111. And, the rubber-coated steel filaments are separated into the three with the wire separator 112, sent to the inlet die 113, gathered in the inlet die 113, and supplied to the buncher (double twist stranding machine) 114 where the three filaments are simultaneously stranded at a predetermined pitch.

In this manner, an elastomer and steel cord composite 116 having a sectional shape shown in FIG. 2 is obtained. In this elastomer and steel cord composite 116, the uncured rubber 117 is coated on all of the steel filaments 115 before stranding, and these filaments coated with the uncured rubber 117 are stranded to fill a cord central portion 118 with the uncured rubber 117 as shown in FIG. 2.

This elastomer and steel cord composite 116 is embedded in a rubber of a tire body in tire component assembling as, for example, a tire reinforcement. In this case, the same material as a tire rubber is used as the uncured rubber 117 previously coated on the steel filaments. And, the uncured rubber 117 is cured in tire component assembling (curing) to completely fill the space in the cord central portion 118, which can prevent the hollow portion from remaining in the cord central portion inside a tire and prevent corrosion from inside the cord owing to moisture or the like to improve fatigue resistance and prolong the life of a tire. Further, since the space in the cord central portion is filled and the amount of air incorporated into the rubber by the cord in tire component assembling is decreased, it is possible to minimize the curing time in tire component assembling or the like and reduce energy loss.

Incidentally, the shown example is a case of a 1 ×3 close cord. The invention can be applied to 1×4, 1×5 and 1×6 close cords too.

Further, in the shown example, the uncured rubber is previously coated on all of the steel filaments to be stranded. It is also possible to completely fill the space in the central portion of the cord by coating the uncured rubber on a part (at least one) of steel filaments.

### 2nd EXAMPLE

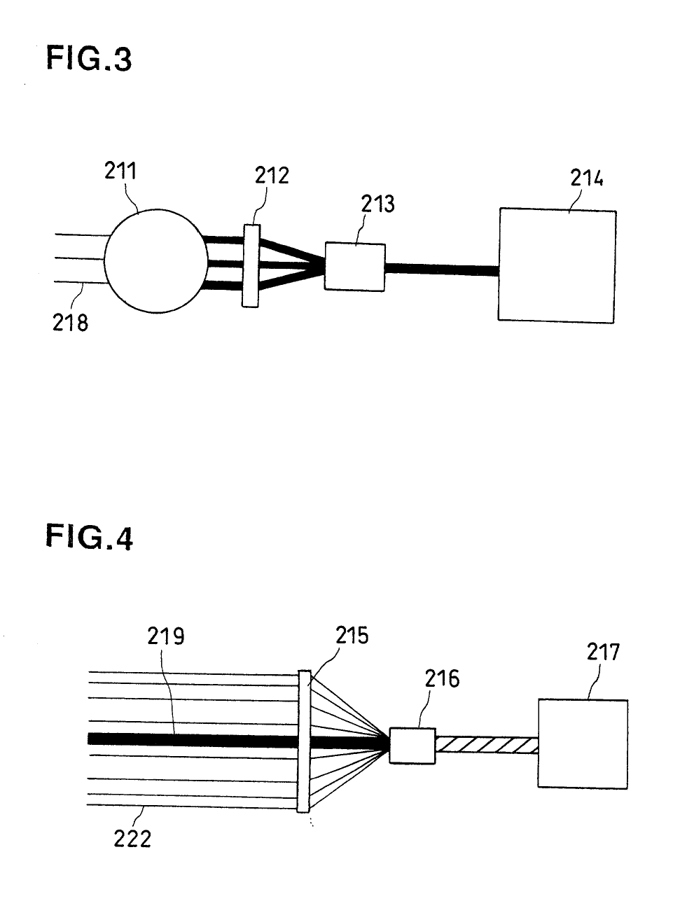

FIG. 3 and FIG. 4 show a process for producing an elastomer and steel cord composite in 2nd Example of the invention. This example is a case of producing a 3 +9 structure of elastomer and steel cord composite. The process comprises a step of forming a core strand (shown in FIG. 3) and a step of stranding outer layer filaments around the core strand (shown in FIG. 4). In FIG. 3, 211 is an uncured rubber coating unit, 212 a wire separator, 213 an inlet die and 214 a buncher (double twist stranding machine). In FIG. 4, 215 is a wire separator, 216 an inlet die and 217 a buncher (double twist stranding machine). All the units are those known per se.

In the step of forming the core strand as shown in FIG. 3, 3 steel filaments 218 as core filaments are fed in parallel, and supplied toward an inlet of the buncher (double twist stranding machine) 214. During the supply, each of the 3 steel filaments 218 is coated with an uncured rubber through the uncured rubber coating unit 211. And, the rubber-coated steel filaments are separated into the three with the wire separator 212, sent to the inlet die 213, gathered in the inlet die 213, and supplied to the buncher (double twist stranding machine) 214 where the 3 filaments are simultaneously stranded at a predetermined pitch.

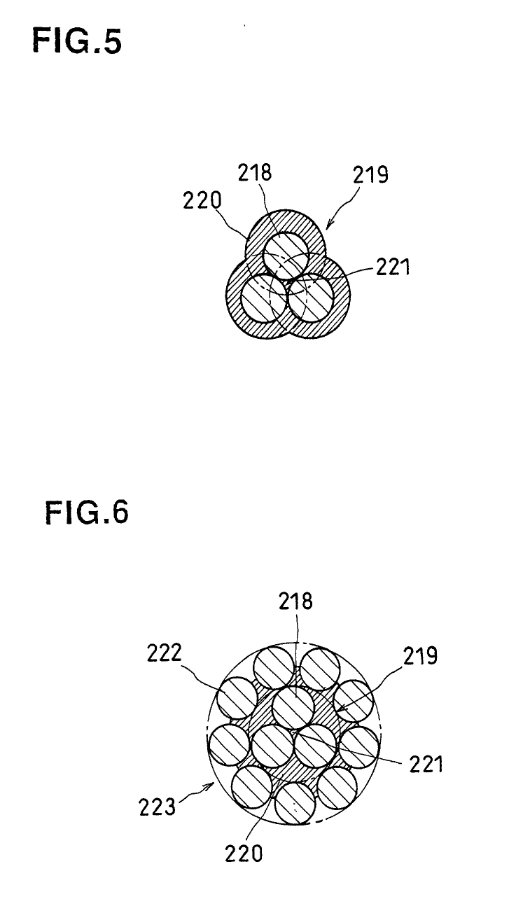

In this manner, the core strand 219 having a sectional shape shown in FIG. 5 is obtained. In this core strand 219, the uncured rubber 220 is coated on all of the steel filaments 218 before stranding, and these filaments coated with the uncured rubber 220 are stranded to fill a strand central portion 221 with the uncured rubber 220 and coat the surroundings with the uncured rubber 220 as shown in FIG. 5.

This core strand 219 is once taken up on a reel. In the subsequent step, as shown in FIG. 4, the core strand 219 and the 9 steel filaments 222 as outer layer filaments are fed in parallel such that the 9 outer layer filaments are arranged around the core strand 219, and supplied toward the inlet of the buncher (double twist stranding machine) 217. The core strand 219 and the 9 outer layer steel filaments 222 were separated with the wire separator 215, sent to the inlet die 216, gathered in the inlet die 216, and supplied to the buncher (double twist stranding machine) 217 to strand the 9 outer layer steel filaments 222 around the core strand 219.

In this manner, a 2-layer elastomer and steel cord composite 223 of which the sectional shape is shown in FIG. 6 is obtained. In this elastomer and steel cord composite 223, the core strand 219 has, as mentioned above, such a structure that the uncured rubber 220 is filled in the strand central portion 221 and the surroundings are coated with the uncured rubber 220. The 9 outer layer steel filaments 222 are stranded therearound to fill the spaces inside the outer layer steel filaments 222 (between the outer layer steel filaments and the core strand) with the uncured rubber 220.

This elastomer and steel cord composite 223 is embedded in the rubber of a tire body in tire component assembling as, for example, a tire reinforcement. In this case, the same material as the tire rubber is used as the uncured rubber 220 to be coated on the steel filaments 218 as core filaments. And, this uncured rubber 220 is cured in tire component assembling (curing), and the spaces inside the cord are completely filled with the rubber. Accordingly, no fretting abrasion occurs, and corrosion from inside the cord owing to moisture or the like can be prevented to improve fatigue resistance of the steel cord and prolong the life of a rubber product such as a tire or the like. Further, since the spaces inside the cord are filled, the amount of air incorporated in the rubber in tire component assembling is decreased, which can allow stable production of a tire and shorten the curing time to reduce energy loss.

Further, the shown example is a case of the (3+9) structure. Another 2-layer steel cord of 2 stranding process in which a core strand is formed of 2 to 4 steel filaments can also be produced.

### 3rd EXAMPLE

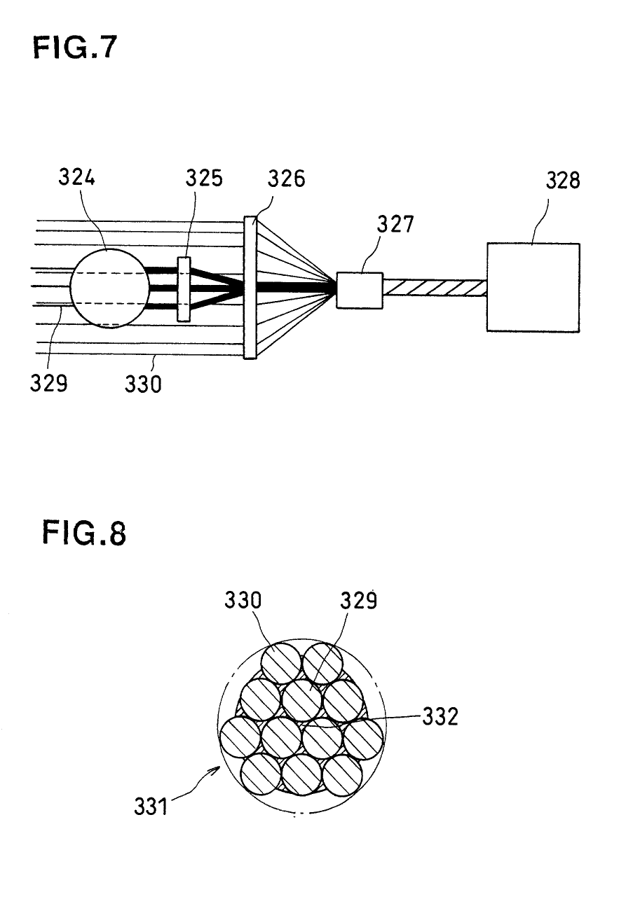

FIG. 7 shows a step of producing an elastomer and steel cord composite in 3rd Example of the invention. This 3rd example is a case of producing a 3/9 structure of elastomer and steel cord composite. In FIG. 7, 324 is an uncured rubber coating unit, 325 and 326 wire separators, 327 an inlet die and 328 a buncher (double twist stranding machine). All the units are those known per se.

In this 3rd Example, 3 steel filaments 329 as core filaments and 9 steel filaments 330 as outer layer filaments are simultaneously fed in parallel such that the 3 steel filaments 329 as core filaments are arranged inside and the 9 outer steel filaments 330 as outer layer filaments are arranged therearound, and supplied toward an inlet of the buncher (double twist stranding machine) 328. During the supply, the uncured rubber is coated on the 3 steel filaments 329 as core filaments with the uncured rubber coating unit 324, passed through the former separator 325, and gathered in the latter wire separator 326. Further, the outer layer steel filaments 330 are directly sent to the latter wire separator 326. The gathered steel filaments 329 coated with the uncured rubber and the 9 outer layer steel filaments 330 are separated with the latter wire separator 326, sent to the inlet die 327, gathered in the inlet die 327, and supplied to the buncher (double twist stranding machine) 328 where the core filaments and the outer layer filaments are stranded in the same direction at the same pitch.

In this manner, the 2-layer elastomer and steel cord composite 331 of which the sectional shape is shown in FIG. 8 is obtained. In the elastomer and steel cord composite 331, the uncured rubber is previously coated on all of the 3 steel filaments 329 as core filaments, and these are stranded along with the 9 steel filaments 330 as outer layer filaments at once, whereby the spaces in the central portion and between the filaments therearound are in a close state, and the uncured rubber 332 is filled in the close spaces.

This elastomer and steel cord composite 331 is also embedded in a rubber of a tire body in tire component assembling as, for example, a tire reinforcement. In this case, the same material as a tire rubber is used as the uncured rubber 332 to be coated on the steel filaments 329 as core filaments. And, this uncured rubber 332 is cured in tire component assembling (curing), and the spaces inside the cord are completely filled with the rubber. Accordingly, no fretting abrasion occurs, and corrosion from inside the owing to moisture or the like can be prevented to improve fatigue resistance of the steel cord and prolong the life of a rubber product such as a tire or the like. Further, since the spaces inside the cord are completely filled with the rubber even in the 2-layer steel cord of 1 stranding process, the amount of air incorporated in the rubber in tire component assembling is decreased, which can allow stable production of a tire and shorten the curing time to reduce energy loss.

By the way, the shown example is a case of the 3/9 structure. Another 2-layer steel cord of 1 stranding process in which plural steel filaments are used as core filaments can also be produced.

### 4th EXAMPLE

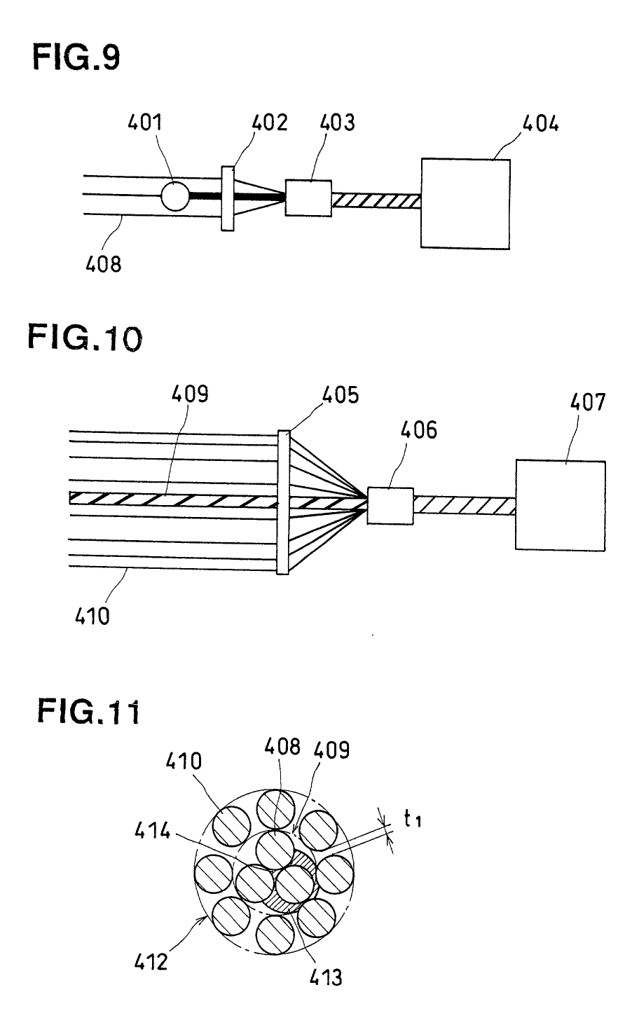

FIG. 9 and FIG. 10 show a process for producing an elastomer and steel cord composite in 4th Example of the invention. This example is a case of producing a (3+8) structure of elastomer and steel cord composite. The process comprises a step of forming a core strand (shown in FIG. 9) and a step of stranding outer layer filaments around the core strand (shown in FIG. 10). In FIG. 9, 401 is an uncured rubber coating unit, 402 a wire separator, 403 an inlet die and 404 a buncher (double twist stranding machine). In FIG. 10, 405 is a wire separator, 406 an inlet die and 407 a buncher (double twist stranding machine). All the units are those known per se.

In the step of forming the core strand as shown in FIG. 9, 3 steel filaments 408 as core filaments are fed in parallel, and supplied toward an inlet of the buncher (double twist stranding machine) 404. During the supply, at least one of the 3 steel filaments 408 is coated with an uncured rubber through the uncured rubber coating unit 401. And, these 3 steel filaments 408 are separated into the three with the wire separator 402, sent to the inlet die 403, gathered in the inlet die 403, and supplied to the buncher (double twist stranding machine) 404 where the 3 filaments are simultaneously stranded at a predetermined pitch. In this manner, the core strand is formed, and once taken up on a reel.

And, in the subsequent step, as shown in FIG. 10, the core strand 409 and the 8 steel filaments 410 as outer layer filaments are fed in parallel such that the 8 outer layer filaments are arranged around the core strand 409, and supplied toward an inlet of the buncher (double twist stranding machine) 407. The core strand 409 and the 8 outer layer steel filaments 410 are separated with the wire separator 405, sent to the inlet die 406, gathered in the inlet die 406, and supplied to the buncher (double twist stranding machine) 407 to strand the 8 outer layer steel filaments 410 around the core strand 409.

In this manner, the 2-layer elastomer and steel cord composite 412 of which the sectional shape is shown in, for example, FIG. 11 is obtained. In this elastomer and steel cord composite 412, the uncured rubber 413 coated on one of the 3 steel filaments 408 constituting the core strand 409 fills the space in the central portion 414 of the strand.

This elastomer and steel cord composite 412 is embedded in a rubber of a tire body in tire component assembling as, for example, a tire reinforcement. In this case, the same material as the tire rubber is used as the uncured rubber 413 to be coated on one of the steel filaments 408 as core filaments. And, this uncured rubber 413 is cured in tire component assembling (curing) and the space in the central portion 414 of the strand is completely filled with the rubber. Further, in the spaces inside the outer layer filaments and between the filaments, the rubber is permeated in combining the rubber of a tire or the like with the cord by curing and pressing.

An elastomer and steel cord composite 412 shown in FIG. 11 is a (3+8) structure using filaments of the same diameter in a core layer and an outer layer. The average clearance t₁ between the steel filaments 410 constituting the outer layer can be set at 2/100 mm or more to provide a good permeability of rubber into the cord when combining the rubber of the rubber product with the cord.

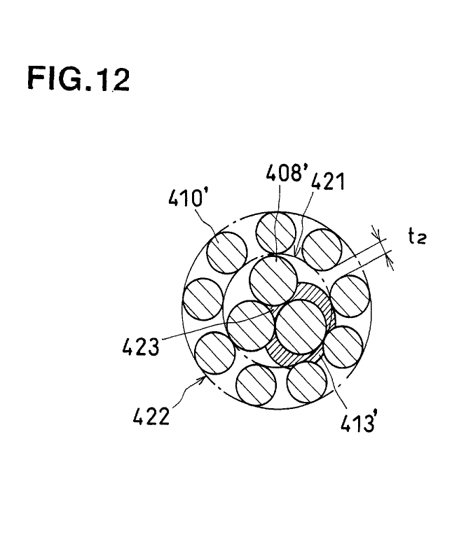

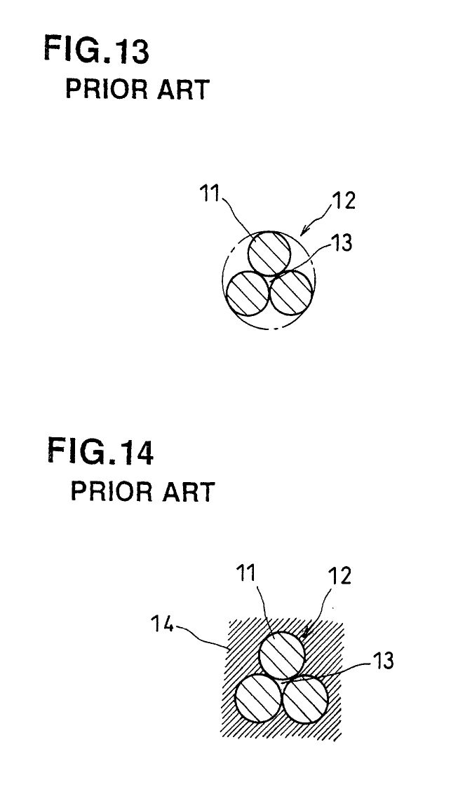

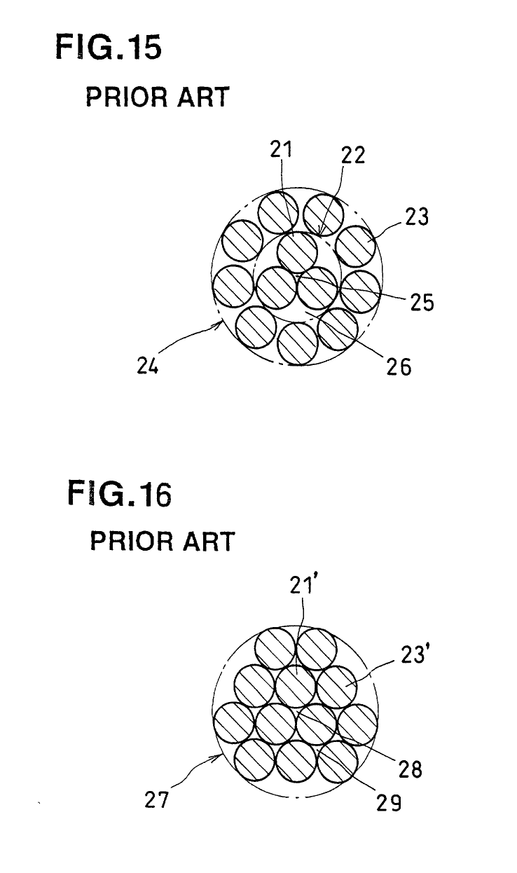

FIG. 12 is a sectional view of another elastomer and steel cord composite in 4th Example, and shows a (3 +9) structure of elastomer and steel cord composite 422 in which the diameter of each steel filament 408′ constituting a core filament 421 is larger than the diameter of each steel filament 410′ constituting an outer layer.

This is also produced in the same manner. In a step of forming the core strand, 3 steel filaments 408′ as core filaments 421 are fed in parallel, and supplied to a buncher (double twist stranding machine). During the supply, an uncured rubber 413′ is coated on one of the 3 steel filaments 408′. In a step of stranding the outer layer filaments, the 9 outer layer steel filaments 410′ each having a smaller diameter are arranged around the core strand 421, and supplied to a buncher (double twist stranding machine) where they are stranded.

In the elastomer and steel cord composite 422 as well, the uncured rubber 413′ coated on one of the 3 steel filaments 408′ constituting the core strand 421 fills the space in the central portion 423 of the strand. And, the uncured rubber 413′ is cured in tire component assembling (curing), and the space in the central portion 423 of the strand is completely filled with the rubber. The rubber permeates the spaces inside the outer layer filaments and between the filaments in combining a rubber of a tire or the like with the cord by curing and pressing.

Further, the elastomer and steel cord composite 422 shown in FIG. 12 is a 3+9 structure in which the diameter of the core filament is larger than the diameter of the outer layer filament, so that an average clearance t₂ between the steel filaments 410′ constituting the outer layer can also be 2/100 mm or more to provide a good permeability of rubber into the cord when combining a rubber of a rubber product with the cord.

Further, the shown examples indicate the 3+8 or 3+9 structure. A 2-layer steel cord of 2 stranding process in which a core strand is formed of 4 steel filaments can also be produced.

Further, in the shown examples, the uncured rubber is coated on one of the steel filaments constituting the core strand. The number of filaments on which to coat the uncured rubber may be 2.

The steel cord for tire reinforcement has been thus far described. The invention can of course be applied to steel cords other than the steel cord for tire reinforcement.

It should be understood that we intend to cover by the appended claims all modifications falling within the true spirit and scope of our invention.

What is claimed is:

1. An elastomer and steel cord composite which is a single layer steel cord obtained by stranding 3 to 6 steel filaments, characterized in that an uncured rubber is coated on at least one of the steel filaments and this uncured rubber fills a space in a central portion of the cord.

2. An elastomer and steel cord composite which is a 2-layer steel cord obtained by stranding plural steel filaments as core filaments to form a core strand and stranding plural steel filaments as outer layer filaments around this core strand, characterized in that an uncured rubber is coated on all of the plural steel filaments as core filaments and this uncured rubber fills the spaces inside the cord.

3. An elastomer and steel cord composite which is a 2-layer steel cord comprising a core layer obtained by stranding 3 or 4 steel filaments and an outer layer formed of plural steel filaments stranded around the core layer, characterized in that an uncured rubber is coated on at least one of the 3 or 4 steel filaments constituting the core layer, and this uncured rubber fills a space in a central portion of the core layer.

4. The elastomer and steel cord composite according to claim 3, wherein the average clearance between the steel filaments constituting the outer layer is 2/100 mm or more.

5. The elastomer and steel cord composite according to claim 1, 2, 3 or 4, characterized in that the uncured rubber has the same quality as a rubber of a tire.

6. A process for producing an elastomer and steel cord composite, characterized by previously coating an uncured rubber on at least one of steel filaments, and simultaneously stranding 3 to 6 steel filaments including the uncured rubber-coated filament to form a single layer elastomer and steel cord composite.

7. The process for producing the elastomer and steel cord composite according to claim 6, characterized in that the uncured rubber is coated on all of the stranded steel filaments.

8. A process for producing an elastomer and steel cord composite, characterized by coating an uncured rubber on all of 2 to 4 steel filaments as core filaments, then simultaneously stranding all of the 2 to 4 steel filaments to form a core strand, and thereafter stranding plural steel filaments as outer layer filaments around the core strand.

9. A process for producing an elastomer and steel cord composite, characterized by coating an uncured rubber on all of plural steel filaments as core filaments with an uncured rubber, arranging plural steel filaments as outer layer filaments around the plural steel filaments coated with the uncured rubber, and stranding all of the steel filaments in the same direction at the same pitch in a 2-layer structure.

10. A process for producing an elastomer and steel cord composite, characterized by coating an uncured rubber on at least one of 3 or 4 steel filaments as core filaments, simultaneously stranding the 3 or 4 steel filaments including the steel filament(s) coated with the uncured rubber to form a core strand, and then stranding plural steel filaments as outer layer filaments around the core strand.

11. The process for producing the elastomer and steel cord composite according to claim 6, 7, 8, 9 or 10, characterized in that the uncured rubber has the same quality as the rubber of a tire.
